(19) United States
(12) Patent Application Publication
(10) Pub. No.: US 2018/0373067 A1
(43) Pub. Date: Dec. 27, 2018

(54) ELECTROABSORPTION OPTICAL MODULATOR

(71) Applicants: NEC CORPORATION, Tokyo (JP); PHOTONICS ELECTRONICS TECHNOLOGY RESEARCH ASSOCIATION, Tokyo (JP)

(72) Inventor: Junichi FUJIKATA, Tokyo (JP)

(73) Assignees: NEC CORPORATION, Tokyo (JP); PHOTONICS ELECTRONICS TECHNOLOGY RESEARCH ASSOCIATION, Tokyo (JP)

(21) Appl. No.: 16/017,038

(22) Filed: Jun. 25, 2018

(30) Foreign Application Priority Data
Jun. 26, 2017 (JP) 2017-124291

(51) Int. Cl. G02F 1/025

(52) U.S. Cl. CPC G02F 1/025; G02F 2001/0157

(57) ABSTRACT

An electroabsorption optical modulator capable of realizing optical coupling with a Si waveguide with high efficiency, improving modulation efficiency, reducing light absorption by an electrode layer and achieving low optical loss includes first Si layer 34 of a first conductive type and second Si layer 35 of a second conductive type disposed parallel to substrate 31 and GeSi layer 51 stacked on the first and second Si layers.

### INCORPORATION BY REFERENCE

This application is based upon and claims the benefit of priority from Japanese patent application No. 2017-124291, filed on Jun. 26, 2017, the disclosure of which is incorporated herein in its entirety by reference.

### TECHNICAL FIELD

The present invention relates to an electroabsorption optical modulator according to an electro-optic effect for high speed conversion of high speed electrical signals into optical signals that is required in the information processing and telecommunications fields.

### BACKGROUND ART

Silicon-based optical communication devices functioning at 1310 and 1550 nm fiber-optic communication wavelengths for a variety of systems such as for fiber-to-the-home and local area networks (LANs) are highly promising technologies which enable integration of optical functioning elements and electronic circuits together on a silicon platform by means of CMOS technologies.

In recent years, silicon-based passive optical devices such as waveguides, couplers and wavelength filters have been studied very extensively. Important technologies for manipulating optical signals for such communication systems include silicon-based active devices such as electro-optic modulators and optical switches, which also have been attracting much attention. However, optical switches and optical modulators that use a thermo-optic effect of silicon to change the refractive index operate at low speed, and accordingly their use is limited to cases of device speeds corresponding to modulation frequencies not higher than 1 Mb/second. Accordingly, in order to realize a high modulation frequency demanded in a larger number of optical communication systems, electro-optic modulators using an electro-optic effect are required.

Most of the electro-optic modulators proposed to date are devices which use a carrier plasma effect to change the free carrier density in a silicon layer and thereby change the real and imaginary parts of the refractive index, thus changing the phase and intensity of light. Such wide use of the above-mentioned carrier plasma effect is because of the fact that pure silicon does not exhibit a linear electro-optic effect (the Pockels effect) and that a change in its refractive index due to the Franz-Keldysh effect or the Kerr effect is very small. In modulators using free carrier absorption, the output light is directly modulated through a change in the absorption rate of light propagating in Si. As a structure using such changes in the refractive index, one employing a Mach-Zehnder interferometer is generally used, where intensity modulated optical signals can be obtained by causing optical phase differences in the two arms that include a phase modulating portion to interfere with each other.

Free carrier density in the electro-optical modulators can be varied by injection, accumulation, depletion or inversion of free carriers. Most of such devices that have been studied to date have low optical modulation efficiency, and accordingly, for optical phase modulation, require a length on the order of millimeters and an injection current density higher than 1 kA/cm³. In order to realize size reduction, higher integration and also a reduction in power consumption, a device structure giving high optical modulation efficiency is required, and if it is achieved, a reduction in the optical phase modulation length becomes possible. If the device size is large, the device becomes susceptible to the influence of temperature distribution over the silicon platform, and it is therefore assumed that a change in the refractive index of the silicon layer caused by a thermo-optic effect due to the temperature distribution cancels out the essentially existing electro-optic effect, thus raising a problem.

FIG. 1 shows a typical example of a silicon-based electro-optic phase modulator that uses a rib waveguide structure formed on an SOI substrate, which is shown in Non-patent Literature 1 (William M. J. Green, Michael J. Rooks, Lidija Sekaric, and Yurii A. Vlasof, Opt. Express 15, 17106-171113 (2007), “Ultra-compact, low RF power, 10 Gb/s silicon Mach-Zehnder modulator”). The electro-optic phase modulator is formed by slab regions that extend in the lateral direction on both sides of a rib-shaped structure including an intrinsic semiconductor region, with the slab regions being formed by a p-type or an n-type doping process, respectively. The aforementioned rib waveguide structure is formed utilizing the Si layer on a silicon-on-insulator (SOI) substrate. The structure shown in FIG. 1 corresponds to a PIN diode type modulator, and is a structure where the free carrier density in an intrinsic semiconductor region is changed by applying forward and reverse biases, and the refractive index is accordingly changed using a carrier plasma effect. In this example, intrinsic semiconductor silicon layer 1 is formed so as to include p-type region 4 subjected to highly concentrated doping in the region in contact with first electrode contact layer 6. In FIG. 1, intrinsic semiconductor silicon layer 1 includes region 5 subjected to still more highly concentrated n-type doping and second electrode contact layer 7 connected thereto. In the above-described PIN diode structure, regions 4 and 5 can also be subjected to doping so as to have a carrier density of approximately 10²⁰ per cm³. In the above-described PIN structure, p-type region 4 and n-type region 5 are arranged on both sides of rib 1 spaced apart from each other, and rib 1 is an intrinsic semiconductor layer.

In terms of the optical modulation operation, the optical modulator is connected to a power supply using the first and second electrode contact layers so as to apply a forward bias to the PIN diode and thereby inject free carriers into the waveguide. When the forward bias is applied, the refractive index of silicon layer 1 is changed as a result of the increase in free carriers, and phase modulation of light transmitted through the waveguide is thereby performed. However, the speed of the optical modulation operation is limited by the lifetime of free carriers in rib 1 and carrier diffusion in rib 1 when the forward bias is removed. Such related art PIN diode phase modulators generally can support only an operation speed in the range of 10 to 50 Mb/second during the forward bias operation.

In this respect, it is possible to increase the switching speed by introducing impurities into the silicon layer, and thereby shorten the carrier lifetime. However, there is the problem that the introduced impurities lower the optical modulation efficiency. The factor that has the greatest influence on the operation speed is a factor caused by the RC time constant, where the capacitance (C) at a time of forward bias application becomes very large as a result of a reduction in the carrier depletion layer width of the PN junction. While, theoretically, high speed operation of the PN junction could be achieved by applying a reverse bias, it requires a relatively high drive voltage or a large device size.

FIG. 2 illustrates a silicon-based electro-optic modulator having an SIS (silicon-insulator-silicon) structure according to WO2004/088394. WO2004/088394 proposes a silicon-based electro-optic modulator including a p-Si4 second conductive type body region and an n-Si5 first conductive type gate region stacked on the second conductive type body region so as to partially overlap the second conductive type body region in which relatively thin dielectric layer 11 is formed on this stack interface. Such a silicon-based electro-optic modulator is formed on an SOI platform, the body region is formed on a relatively thin silicon surface layer of the SOI substrate and the gate region is made up of a relatively thin silicon layer stacked on the SOI structure. The interiors of the gate and the body regions are doped and the doped regions are defined so that variations in carrier density are controlled by an external signal voltage. In this case, ideally, it is desirable to make an optical signal electric field coincide with the region where the carrier density is externally and dynamically controlled, in which situation optical phase modulation can be performed by accumulating, depleting or inverting free carriers on each side of dielectric layer 11. However, in practice there is a problem in that the region where the carrier density dynamically changes is an extremely thin region with a size of about several tens of nanometers, which results in the problem that an optical modulation length on the order of millimeters is required, and the electro-optic modulator accordingly becomes large in size, and consequently high speed operation is difficult.

On the other hand, an electroabsorption optical modulator using GeSi which is the same group IV semiconductor material is proposed as a silicon-based electro-optic modulator which can be downsized and operated at high speed. Non-patent Literature 2 (Dazeng Feng, Wei Qian, Hong Liang, Cheng-Chih Kung, Zhou Zhou, Zhi Li, Jacob S. Levy, Roshanak Shafiiha, Joan Fong, B. Jonathan Luff, and Mehdi Asghari, IEEE JOURNAL OF SELECTED TOPICS IN QUANTUM ELECTRONICS, VOL. 19, NO. 6, 3401710, NOVEMBER/DECEMBER 2013) reports a butt-joint coupled GeSi electroabsorption optical modulator directly optically coupled with a silicon waveguide.

FIG. 3 shows a schematic cross-sectional view of the butt-joint coupled GeSi electroabsorption optical modulator described in Non-patent Literature 2. The modulator includes i-GeSi 21 formed between p⁺-GeSi 22 and n⁺-GeSi 23, which are electrode layers, on Si slab 24 of an SOI substrate.

It is a problem with the electroabsorption optical modulator using GeSi disclosed in Non-patent Literature 2 how to efficiently optically couple with a Si waveguide, improve modulation efficiency, reduce light absorption by the electrode layer and achieve low optical loss. It is another problem with the electroabsorption optical modulator that the operation wavelength band is narrow and the operation wavelength band varies along with a temperature variation.

Although this GeSi electroabsorption optical modulator is enabled to operate at high speed, the electrode layer is formed by stacking a GeSi layer on the Si waveguide and subjecting the GeSi layer to p-type or n-type doping, which results in a problem that the optical coupling length increases and light absorption loss by the p- or n-doped GeSi electrode layer is large.

### SUMMARY

It is an object of the present invention to provide an electroabsorption optical modulator capable of realizing highly efficient optical coupling with a Si waveguide, improving modulation efficiency, reducing light absorption by an electrode layer and achieving low optical loss.

One aspect of the present invention relates to an electroabsorption optical modulator that includes a first silicon layer doped to exhibit a first type of conductivity and a second silicon layer doped to exhibit a second type of conductivity that are disposed parallel to a substrate; and a GeSi layer stacked on the first and second silicon layers.

Another aspect of the present invention relates to an electro-optic modulation apparatus that include at least two units of the above electroabsorption optical modulator optically connected via a Si-based optical waveguide, an input port and an output port; and at least one pair of the electroabsorption optical modulators is driven by a differential drive circuit.

A further aspect of the present invention relates to an optical integrated circuit that includes the above electroabsorption optical modulator or the above electro-optic modulation apparatus and a light receiver including a GeSi layer in a light receiving section, on one substrate, wherein the GeSi layer of the electroabsorption optical modulator and the GeSi layer of the light receiver are adjusted by a bias voltage to function as an electroabsorption optical modulator and a light receiver.

According to one aspect of the present invention, it is possible to provide an electroabsorption optical modulator using GeSi capable of realizing highly efficient optical coupling with a Si waveguide, improving modulation efficiency, reducing light absorption by an electrode layer and achieving low optical loss.

### BRIEF DESCRIPTION OF THE DRAWINGS

FIG. 1 is a cross-sectional view of an electro-optic modulator including a PIN structure according to the background art;

FIG. 2 is a cross-sectional view of an electro-optic modulator including an SIS structure according to the background art;

FIG. 3 is a schematic cross-sectional view of a GeSi electroabsorption optical modulator using GeSi according to the background art;

FIG. 4 is a schematic cross-sectional view of a structure example of an electroabsorption optical modulator using GeSi according to one example embodiment of the present invention;

FIG. 5 is a schematic cross-sectional view of a structure example of an electroabsorption optical modulator using GeSi according to one example embodiment of the present invention;

FIG. 6 is a schematic cross-sectional view of an electroabsorption optical modulator in which a layer giving lattice distortion is stacked on the GeSi layer according to one example embodiment of the present invention;

FIGS. 7A to 7I are cross-sectional views illustrating manufacturing processes of the electroabsorption optical modulator using GeSi according to one example embodiment of the present invention;

FIG. 8 is a plan view illustrating a structure example in which a pair of GeSi optical modulators according to one example embodiment of the present invention are connected via an optical waveguide and differentially driven; and

FIG. 9 is a configuration diagram illustrating an example embodiment where a pair of electroabsorption optical modulators according to one example embodiment of the present invention are connected via a Si waveguide and driven by a differential circuit.

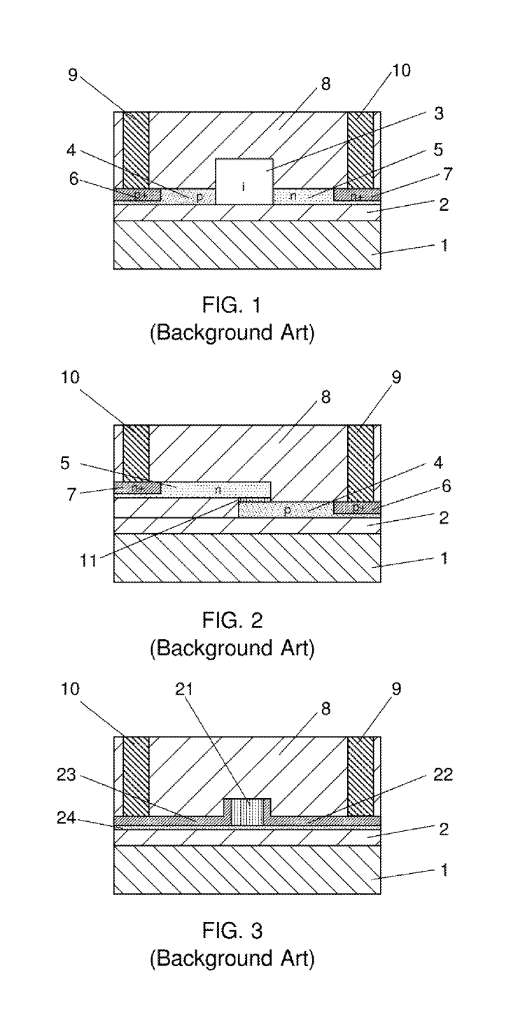

### EXAMPLE EMBODIMENT

Hereinafter, the present invention will be described with example embodiments.

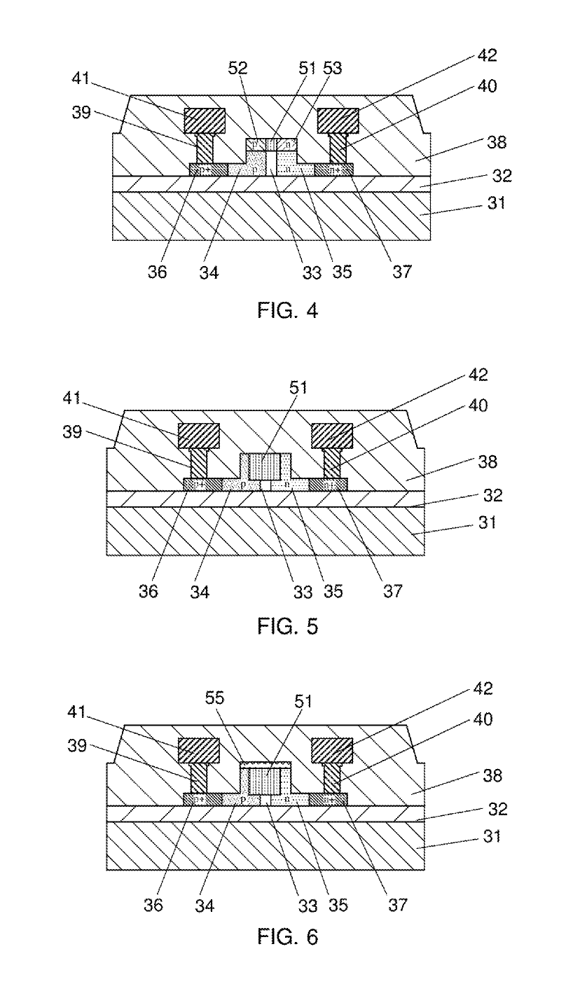

In an electro-optic modulator (electroabsorption optical modulator) according to the present example embodiment, as shown in FIG. 4, by forming first silicon (Si) layer 34 doped so as to exhibit a first type of conductivity (for example, p-type conductivity) and second silicon (Si) layer 35 doped so as to exhibit a second type of conductivity (for example, n-type conductivity), both being disposed parallel to support substrate 31 of an SOI substrate via buried oxide (BOX) layer 32 which constitutes a lower clad, stacking germanium-silicon (GeSi) layer 51 on the doped first and second Si layers, further subjecting the GeSi layer to p-type and n-type doping to form electrode layers 52 and 53, it is possible to reduce light absorption by the electrode layers. Note that support substrate 31 and BOX layer 32 may be simply collectively called a “substrate.”

In this case, third Si layer 33 made up of an intrinsic semiconductor can be inserted between first Si layer 34 and second Si layer 35. That is, the insertion of third Si layer 33 made up of the intrinsic semiconductor improves light absorption by the first and second Si layers subjected to p-type and n-type doping.

In this case, by making first Si layer 34 and second Si layer 35 disposed parallel to support substrate 31 have a rib type waveguide structure, it is possible to attract an optical mode field toward the Si layer side and reduce optical loss in the GeSi layer in which the electrode is formed through p-type and n-type doping.

According to another example embodiment, as shown in FIG. 5, at least part of GeSi layer 51 is embedded in the Si layers (33 to 35) directly connected to the Si waveguide to have a butt coupling structure, the optical coupling length is made smaller than the conventional length, the Si layers (34, 35) adjacent to GeSi layer 51 are subjected to p-type and n-type doping to be used as electrode layers and light absorption by the electrode layers is thereby reduced. Furthermore, large tensile distortion is applied to GeSi layer 51 embedded in the Si layer due to a difference in thermal expansion coefficient between the Si layer and GeSi layer 51 to be embedded, and so a Franz-Keldysh effect is enhanced.

In FIGS. 4 and 5 in common, first Si layer 34 and second Si layer 35 are connected to first and second contact layers 36 and 37 doped with the same conductive type impurity at high concentration respectively, and further connected to contact electrodes 39 and 40, and wiring layers 41 and 42 (the contact electrode and the wiring layer are collectively called “electrode wiring”). They are entirely covered with oxide layer 38 which constitutes an upper clad. Light intensity modulation is enabled by applying an electric field to GeSi layer 51 via the electrode wiring and realizing an electro-optic effect.

As for the Ge vs. Si composition in GeSi layer 51, a Ge composition of 90 atomic % or higher is preferable. This is because as the Si composition increases, the electro-optic effect decreases and the drive voltage also increases. Since a relatively large electro-optic effect is obtained with pure Ge, by applying distortion and reducing the band gap, light intensity modulation at 1550 nm which is a communication wavelength band is also possible.

When driving is done using a CMOS driver, low voltage operation is realized by connecting two or more GeSi optical modulators via the optical waveguide and differentially driving them, and waveform symmetry can also be improved by independently controlling DC bias voltages to be applied to the two or more GeSi optical modulators. By controlling the two or more GeSi layers so as to have different compositions, the operation wavelength band can be improved.

Furthermore, as shown in FIG. 6, by stacking a layer that gives lattice distortion to GeSi layer 51 (distortion applying layer 55) on GeSi layer 51, the electroabsorption optical modulator is enabled to generate light intensity modulation at a lower voltage. Distortion applying layer 55 can also be formed on GeSi layers (51 to 53) shown in FIG. 4. In this case, band gap energy is reduced by applying biaxial distortion to the <110> crystal orientation of the GeSi layer, and light intensity modulation can be achieved at a lower voltage and with high efficiency.

As shown in FIG. 5, in a structure in which GeSi layer 51 is embedded, by forming a GeSi layer (not shown) subjected to p-type or n-type doping on interfaces between the first and second Si layers subjected to p-type or n-type doping and GeSi layer 51, the width of GeSi layer 51 disposed between the p-type electrode layer and the n-type electrode layer is reduced and light intensity modulation can be generated at a lower voltage.

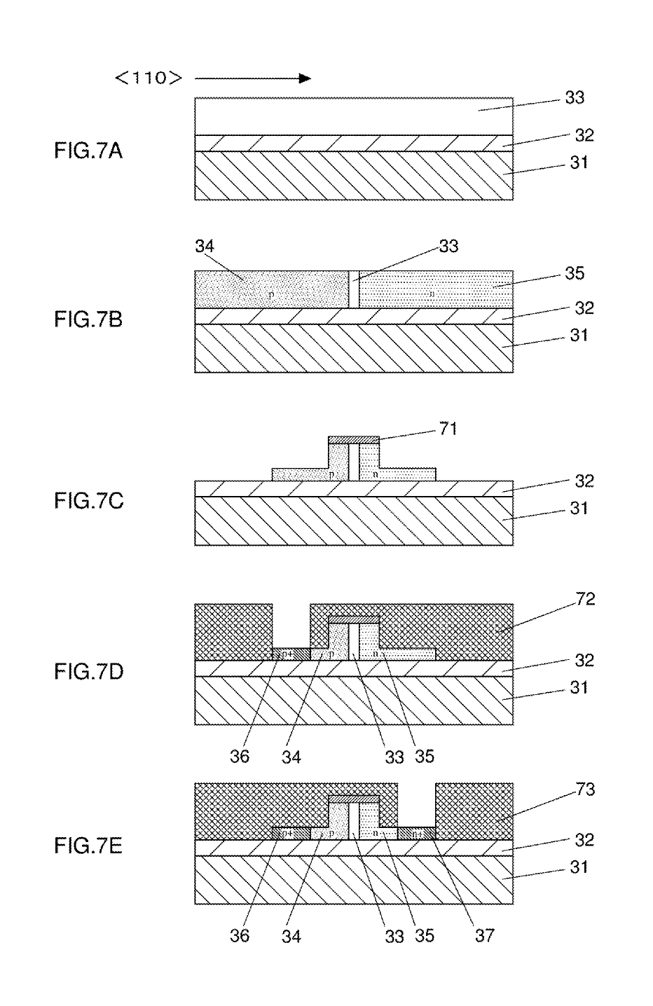

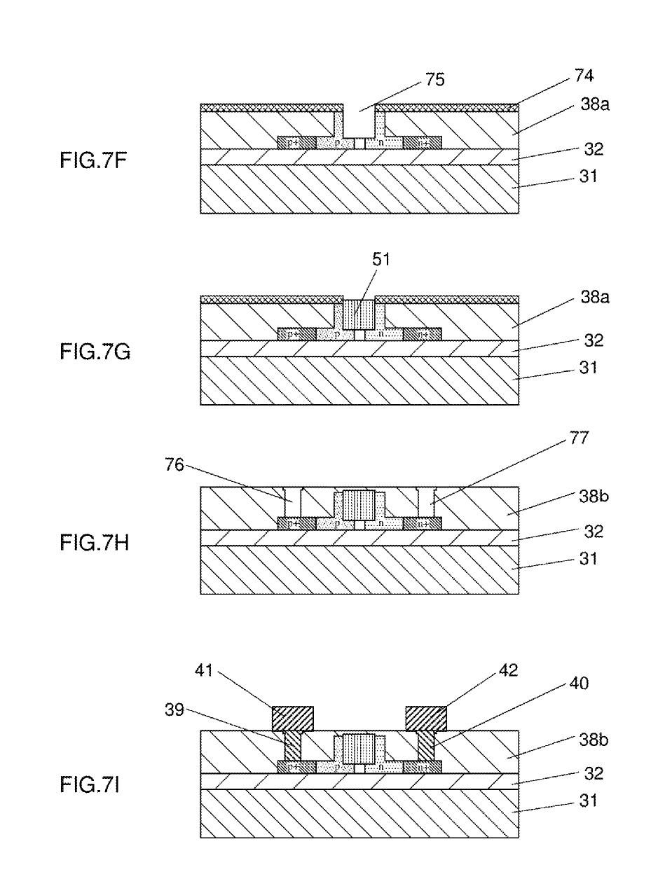

Next, a manufacturing method for the electro-optic modulator according to an example embodiment will be described. FIGS. 7A to 7I are cross-sectional views of steps of an example of the method of forming the electro-optic modulator in which GeSi layer 51 shown in FIG. 5 is embedded.

FIG. 7A is a cross-sectional view of an SOI substrate used to form the electroabsorption optical modulator of the present invention. The SOI substrate has a structure in which Si layer 33 having a thickness on the order of 100 to 1000 nm is stacked on BOX layer 32, and a structure with the BOX layer having a thickness of 1000 nm or more is applied in order to reduce optical loss. As shown in FIG. 7B, the surface layer of Si layer 33 on BOX layer 32 is subjected to a doping process with P or B by ion implantation exhibiting first and second conductive types, then given heat treatment, and an electrode layer made up of first Si layer 34 and second Si layer 35 is thereby formed. Note that since Si layer 33 on BOX layer 32 is set so that the <110> crystal orientation is substantially parallel to a direction of an applied electric field by the electrode, a greater electric field absorption effect can be obtained at a low voltage.

Next, as shown in FIG. 7C, a stacked structure of an oxide mask layer and a SiNₓ hard mask layer is formed as mask 71 to form a rib waveguide shape and the stacked structure is patterned using UV lithography and a dry etching method or the like. First and second Si layers 34 and 35 are patterned using mask 71 to obtain the rib waveguide shape.

Next, as shown in FIGS. 7D and 7E, some regions of first and second Si layers 34 and 35 are doped with highly concentrated B ions and P ions using an ion implantation method to sequentially form first and second contact layers 36 and 37. At this time, other regions are protected with masks 72 and 73 such as resists.

Next, as shown in FIG. 7F, oxide clad 38a for selective epitaxial growth (called “selective epitaxy”) of the GeSi layer is stacked. In this case, applying a flattening process using a CMP (chemical mechanical polishing) method facilitates an opening process in the oxide clad for selective epitaxy of the GeSi layer. After removing mask 71 and forming mask 74, opening 75 for selective epitaxy of the GeSi layer is formed in the Si layer on the rib waveguide to allow selective epitaxial growth of GeSi layer 51 to take place as shown in FIG. 7G.

Next, as shown in FIG. 7H, an oxide having a thickness on the order of 1 μm is further stacked as oxide clad 38b and contact holes 76 and 77 to make electric contacts with first and second contact layers 36 and 37 are formed using a dry etching method or the like.

Finally, as shown in FIG. 7I, a metal layer such as Ti/TiN/Al (Cu) or Ti/TiN/W is formed using a sputtering method or a CVD method, patterned by reactive etching and electrode wiring made up of contact electrodes 39 and 40, and wiring layers 41 and 42 is formed to make connections with the drive circuit. After that, an oxide is further stacked to complete the electro-optic modulator shown in FIG. 5.

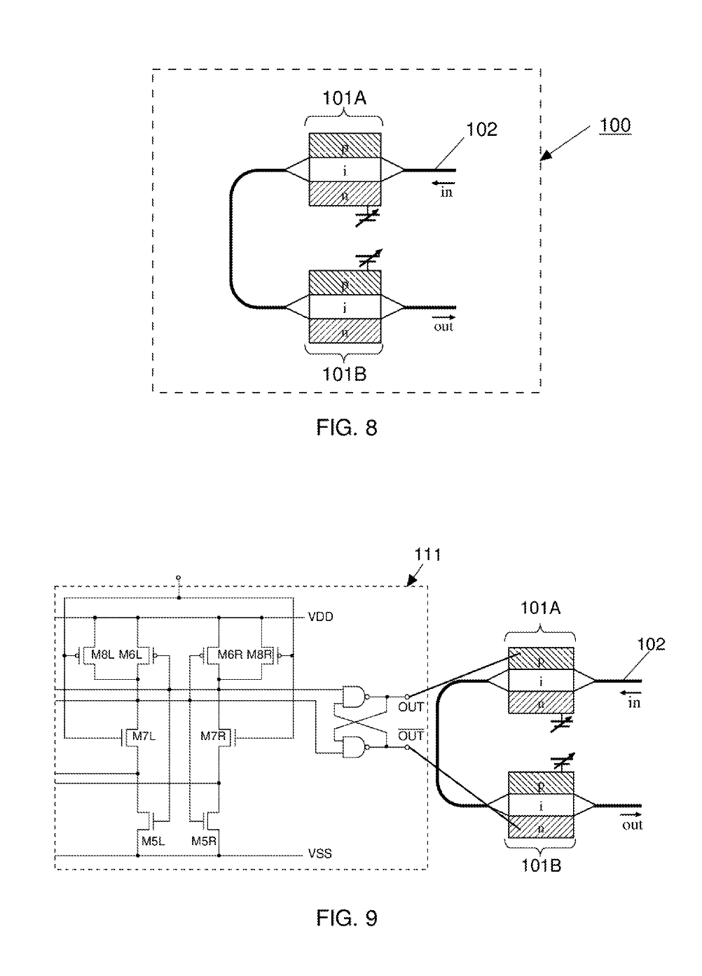

In the electroabsorption optical modulator according to the example embodiment, a pair of two electroabsorption optical modulators 101A and 101B are connected in series via Si-based optical waveguide 102 as shown in FIG. 8 and input/output ports are set, to thereby constitute electro-optic modulation apparatus 100. Electro-optic modulation apparatus 100 can be driven by differential drive circuit 111 as shown in FIG. 9. Driving by differential drive circuit 111 makes it possible to generate light intensity modulation with higher efficiency. The number of electroabsorption optical modulators connected in series can be at least two, but is not limited. In this case, since electric signals with different polarities are applied from differential drive circuit 111, the electroabsorption optical modulators are arranged so that electric signals with different polarities and DC bias voltages are applied to the p-type electrode and the n-type electrode of the pair of electroabsorption optical modulators respectively.

Electro-optic modulation apparatus 100 including at least a pair of electroabsorption optical modulators is enabled to perform waveform shaping such as symmetry of output waveforms by controlling DC bias voltages independently of each other.

Furthermore, electro-optic modulation apparatus 100 including at least a pair of the electroabsorption optical modulators is enabled to expand the operation wavelength band by causing the respective GeSi layers to have different germanium (Ge) concentrations.

In one example embodiment, it is possible to implement an optical integrated circuit that integrates a GeSi electroabsorption optical modulator and a light receiver by collectively forming the electroabsorption optical modulator and a light receiver (not shown) which includes a GeSi layer in a light receiving section on the same SOI platform and by adjusting the functions as a modulator and a light receiver by bias voltages. Similarly, the above electro-optic modulation apparatus can be integrated with the light receiver that is optically connected to the output port of the electro-optic modulation apparatus on one substrate (same SOI platform).

The example embodiment shown in FIG. 9 optically connects at least a pair of the electroabsorption optical modulators of the present invention via a Si-based optical waveguide, sets input/output ports and drives the electroabsorption optical modulators by the differential drive circuit. This makes it possible to increase an effective drive voltage, achieve high optical modulation efficiency and reduce high frequency noise generated from the transmission circuit by the differential drive pair.

In this case, at least a pair of the electroabsorption optical modulators can perform waveform shaping such as symmetry of output waveforms by independently controlling the DC bias voltages.

At least the pair of the electroabsorption optical modulators causes the GeSi layers to have different Ge concentrations, and can thereby expand their operation wavelength bands and improve output variations with respect to temperature variations.

The electroabsorption optical modulator according to the present example embodiment can improve light absorption efficiency by a DC bias voltage. After collectively forming GeSi layers as the light receiver and the GeSi layer as the electroabsorption optical modulator, it is actually possible to implement an optical integrated circuit that causes the GeSi layers to function as an optical modulator and a light receiver through DC bias voltage control.

Although the present invention has been described above referring to example embodiments, the present invention is not limited to the above-described example embodiments. Various changes that can be understood by one skilled in the art can be made to the configuration and details of the present invention within the scope of the present invention.

### SUPPLEMENTARY NOTE

The whole or part of the example embodiments disclosed above can be described as, but not limited to, the following supplementary notes:

### Supplementary Note 1

An electroabsorption optical modulator comprising:

a first silicon layer doped to exhibit a first type of conductivity and a second silicon layer doped to exhibit a second type of conductivity that are disposed parallel to a substrate; and

a GeSi layer stacked on the first and second silicon layers.

### Supplementary Note 2

The electroabsorption optical modulator according to Supplementary Note 1, wherein

the first and second silicon layers are fabricated into a rib waveguide shape.

### Supplementary Note 3

The electroabsorption optical modulator according to Supplementary Note 1 or 2, wherein

a third silicon layer being an intrinsic semiconductor is inserted between the first and second silicon layers.

### Supplementary Note 4

The electroabsorption optical modulator according to any one of Supplementary Notes 1-3, wherein

the GeSi layer is embedded so that at least part of the GeSi layer is sandwiched between the first and second silicon layers.

### Supplementary Note 5

The electroabsorption optical modulator according to any one of Supplementary Notes 1-4, wherein

a layer for giving lattice distortion to the GeSi layer is stacked on the GeSi layer.

### Supplementary Note 6

The electroabsorption optical modulator according to Supplementary Note 5, wherein

the layer for giving lattice distortion to the GeSi layer is a layer that applies distortion in a <110> direction of the GeSi layer.

### Supplementary Note 7

The electroabsorption optical modulator according to any one of Supplementary Notes 1-6, wherein

the GeSi layer is electrically connected to the first silicon layer via a GeSi layer doped to exhibit to a first type of conductivity and the second silicon layer via a GeSi layer doped to exhibit to a second type of conductivity, respectively.

### Supplementary Note 8

The electroabsorption optical modulator according to any one of Supplementary Notes 1-7, wherein

a concentration of germanium atom in the GeSi layer is 90 atomic % or higher in respect to total 100 atomic % of silicon and germanium atoms.

### Supplementary Note 9

An electro-optic modulation apparatus comprising:

at least two units of the electroabsorption optical modulator according to any one of Supplementary Notes 1-8 optically connected via a Si-based optical waveguide, an input port and an output port; and

at least one pair of the electroabsorption optical modulators is driven by a differential drive circuit.

### Supplementary Note 10

The electro-optic modulation apparatus according to Supplementary Note 9, wherein

the differential drive circuit performs waveform shaping on output waveforms by independently controlling DC bias voltages of the electroabsorption optical modulators to be paired.

### Supplementary Note 10

The electro-optic modulation apparatus according to Supplementary Note 9 or 10, wherein

germanium concentrations of the GeSi layers of the respective electroabsorption optical modulators to be paired are set to different concentrations.

### Supplementary Note 12

An optical integrated circuit comprising on one substrate:

the electroabsorption optical modulator according to any one of Supplementary Notes 1-8 and

a light receiver including a GeSi layer in a light receiving section,

wherein the GeSi layer of the electroabsorption optical modulator and the GeSi layer of the light receiver are adjusted by a bias voltage to function as an electroabsorption optical modulator and a light receiver.

### Supplementary Note 13

An optical integrated circuit comprising on one substrate:

the electro-optic modulation apparatus according to any one of Supplementary Notes 9-11 and

a light receiver including a GeSi layer in a light receiving section and optically connected to the output port of the electro-optic modulation apparatus,

wherein the GeSi layers of the electroabsorption optical modulators in the electro-optic modulation device and the GeSi layer of the light receiver are adjusted by a bias voltage to function as an electroabsorption optical modulator and a light receiver.

### Supplementary Note 14

A method for driving an electro-optic modulation apparatus comprising at least two units of the electroabsorption optical modulator according to any one of Supplementary Notes 1-8 optically connected via a Si-based optical waveguide, an input port and an output port, which comprising:

driving at least one pair of the electroabsorption optical modulators by a differential drive circuit.

### Supplementary Note 15

The method according to Supplementary Note 14, wherein

the differential drive circuit performs waveform shaping on output waveforms by independently controlling DC bias voltages of the electroabsorption optical modulators to be paired.

### Supplementary Note 16

The method according to Supplementary Note 14 or 15, wherein

germanium concentrations of the GeSi layers of the respective electroabsorption optical modulators to be paired are set to different concentrations.

What is claimed is:

1. An electroabsorption optical modulator comprising:
a first silicon layer doped to exhibit a first type of conductivity and a second silicon layer doped to exhibit a second type of conductivity that are disposed parallel to a substrate; and
a GeSi layer stacked on the first and second silicon layers.

2. The electroabsorption optical modulator according to claim 1, wherein
the first and second silicon layers are fabricated into a rib waveguide shape.

3. The electroabsorption optical modulator according to claim 1, wherein
a third silicon layer being an intrinsic semiconductor is inserted between the first and second silicon layers.

4. The electroabsorption optical modulator according to claim 1, wherein
the GeSi layer is embedded so that at least part of the GeSi layer is sandwiched between the first and second silicon layers.

5. The electroabsorption optical modulator according to claim 1, wherein
a layer for giving lattice distortion to the GeSi layer is stacked on the GeSi layer.

6. The electroabsorption optical modulator according to claim 5, wherein
the layer for giving lattice distortion to the GeSi layer is a layer that applies distortion in a <110> direction of the GeSi layer.

7. The electroabsorption optical modulator according to claim 1, wherein
the GeSi layer is electrically connected to the first silicon layer via a GeSi layer doped to exhibit to a first type of conductivity and the second silicon layer via a GeSi layer doped to exhibit to a second type of conductivity, respectively.

8. The electroabsorption optical modulator according to claim 1, wherein
a concentration of germanium atom in the GeSi layer is 90 atomic % or higher in respect to total 100 atomic % of silicon and germanium atoms.

9. An electro-optic modulation apparatus comprising:
at least two units of the electroabsorption optical modulator according to claim 1 optically connected via a Si-based optical waveguide, an input port and an output port; and
at least one pair of the electroabsorption optical modulators is driven by a differential drive circuit.

10. The electro-optic modulation apparatus according to claim 9, wherein
the differential drive circuit performs waveform shaping on output waveforms by independently controlling DC bias voltages of the electroabsorption optical modulators to be paired.

11. The electro-optic modulation apparatus according to claim 9, wherein
germanium concentrations of the GeSi layers of the respective electroabsorption optical modulators to be paired are set to different concentrations.

12. An optical integrated circuit comprising on one substrate:
the electroabsorption optical modulator according to claim 1 and
a light receiver including a GeSi layer in a light receiving section,
wherein the GeSi layer of the electroabsorption optical modulator and the GeSi layer of the light receiver are adjusted by a bias voltage to function as an electroabsorption optical modulator and a light receiver.

13. An optical integrated circuit comprising on one substrate:
the electro-optic modulation apparatus according to claim 9 and
a light receiver including a GeSi layer in a light receiving section and optically connected to the output port of the electro-optic modulation apparatus,
wherein the GeSi layers of the electroabsorption optical modulators in the electro-optic modulation device and the GeSi layer of the light receiver are adjusted by a bias voltage to function as an electroabsorption optical modulator and a light receiver.

14. A method for driving an electro-optic modulation apparatus comprising at least two units of the electroabsorption optical modulator according to claim 1 optically connected via a Si-based optical waveguide, an input port and an output port, which comprising:
driving at least one pair of the electroabsorption optical modulators by a differential drive circuit.

15. The method according to claim 14, wherein
the differential drive circuit performs waveform shaping on output waveforms by independently controlling DC bias voltages of the electroabsorption optical modulators to be paired.

16. The method according to claim 14, wherein
germanium concentrations of the GeSi layers of the respective electroabsorption optical modulators to be paired are set to different concentrations.
